(19) United States
(12) Patent Application Publication
(10) Pub. No.: US 2023/0410015 A1
(43) Pub. Date: Dec. 21, 2023

(54) DASHBOARD ANALYSIS USING COMPUTATION ENGINE FOR PIPELINE PERFORMANCE MANAGEMENT

(71) Applicant: Premonio, Inc., Redwood City, CA (US)

(72) Inventor: Johannes Hoech, Redwood City, CA (US)

(73) Assignee: Premonio, Inc., Redwood City, CA (US)

(21) Appl. No.: 18/211,609

(22) Filed: Jun. 20, 2023

Related U.S. Application Data
(60) Provisional application No. 63/353,864, filed on Jun. 21, 2022.

(51) Int. Cl. G06Q 10/0637

(52) U.S. Cl. CPC G06Q 10/0637

(57) ABSTRACT

Techniques for dashboard analysis using a computation engine for pipeline performance management are disclosed. A predictive growth algorithm is selected from a plurality of predictive growth algorithms using a software dashboard graphical user interface (SD-GUI). Enterprise-specific revenue goals are developed, employing code executed as a result of using the SD-GUI. The enterprise-specific revenue goals are based on the selected predictive growth algorithm. The revenue goals are disaggregated into subgoals for portions of the enterprise. The portions correspond to enterprise input pipelines. A relationship between the enterprise-specific revenue goals and the input pipelines is quantified. Data from the input pipelines corresponding to the subgoals is evaluated employing executed code. One or more deficiencies in the data are identified with respect to accomplishing one or more of the subgoals, employing executed code.

### RELATED APPLICATIONS

This application claims the benefit of U.S. provisional patent application “Dashboard Analysis Using Computation Engine For Pipeline Performance Management” Ser. No. 63/353,864, filed Jun. 21, 2022.

The foregoing application is hereby incorporated by reference in its entirety.

### FIELD OF ART

This application relates generally to analysis and more particularly to dashboard analysis using computation engines for pipeline performance management.

### BACKGROUND

For millennia, people have obtained and exchanged goods and services through markets. Such a market is a physical space that is conveniently located for sellers and buyers alike. Sellers bring their wares to the market with the intention of selling them at a profit. The profit can be large or small depending on the quality of the goods or services, availability of the goods or services from other sellers, or the willingness of buyers to pay the asked for price, among other factors. The buyers, on the other hand, come to the market to perhaps buy goods or services, but also to browse, to be entertained, or simply to kill time. Further, the buyers who go to the market to make a purchase compare prices from different sellers, examine the quality of the goods or appropriateness of the services, and argue over price. If the seller has a hope for making a sale, the seller must demonstrate to the buyer reasons why the buyer should do business with that seller. At times, however, the situation is reversed. Particular goods may be in short supply, so the selling prices go up. The seller may not be able to make or obtain additional goods at the previous buying price, so is unwilling to lower their price just to make a sale. If the buyer needs to purchase the product, they are left with the choices of paying the higher price or doing without. The latter option may not be possible for the buyer such as when buying food, medicine, or fuel.

The process of buyers and sellers meeting in a central location has advanced. The “agora” of ages past has given way to Internet websites, specialized boutiques, and large, generalized box stores. As a result, the competition among the vendors to reach potential buyers and to get those potential buyers to buy from the vendors is fierce. A buyer can easily perform a web search to learn about the myriad of products and services that can meet their particular buying needs. A search for “enterprise software” can quickly reveal millions of search results on the web. Among those results, the potential buyer will find products for sale, review sites, blogs, videos, and a wide variety of other results that range from the practical to the useless. When the potential buyer has found what they are actually looking for, they can compare prices and support costs. When ready, the buyer can make their purchase online or have the purchase delivered to their doorstep.

### SUMMARY

Products and services are available for sale to customers from a wide variety of enterprises. Each enterprise seeks to differentiate its products and services from other offerings in terms of quality, pricing, desirability, and so on. Further, each enterprise seeks to identify a competitive advantage over its rivals in order to increase market share and revenue. However, the marketplace can be fickle. An item that is a “must-have” during one retail season may sell for ten cents to a dollar the next season. Certain functions, branding, or value propositions that sell out quickly now may be undesirable later. A new product or service, no matter how well designed and developed, will not sell if it cannot create new or break into existing, competitive markets. Nowadays a product or service must be easily found by potential buyers online and must quickly communicate clear advantages over what is available from competing enterprises which are also vying for sales. Advertising alone does not guarantee success of a product or service. Further, advertising can be very expensive and at times ineffective. As one marketing executive put it, they knew they were wasting half of their advertising budget but did not know which half.

Revenue forecasting estimates sales income by predicting a quantity of products or services that a sales unit can sell over a period of time. Whether the sales unit is an individual salesperson, a sales team, an online marketing campaign, or an entire enterprise; and the period of time is a day, week, month, or a year; the objective of the enterprise remains the same. The enterprise desires to forecast future revenue as accurately as possible. An accurate forecast enables the enterprise to predict what revenue is likely to be realized, thus enabling the enterprise to expand operations, develop new products and services, and the like. The predicting future revenue can be based on analyzing historical data such as sales data to predict future sales. The historical data can indicate seasonal sales trends showing which products and services were popular with customers. Revenue forecasting based on historical data is possible only when such data is available, has been collected, and is available for analysis. However, when a product or service is new to the market or stands alone, or the enterprise is new enough not to have historical data, or the enterprise is in a turnaround mode, then predicting future sales based on historical data alone is not possible. Instead, predictive and adaptive techniques that do not require data but can course-correct quickly, as needed, to adapt sales units to new and evolving revenue attainment, can be used.

Analysis is based on dashboard analysis using a computation engine for pipeline performance management. A predictive growth algorithm is selected from a plurality of predictive growth algorithms using a software dashboard graphical user interface. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data from the input pipelines corresponding to the subgoals is evaluated by employing code executed as a result of using the software dashboard graphical user interface. One or more deficiencies in the data, with respect to accomplishing one or more of the subgoals, are identified by employing code executed as a result of using the software dashboard graphical user interface. Further action is recommended by the software dashboard graphical user interface to correct the one or more deficiencies to achieve the one or more subgoals.

A computer-implemented method for analysis is disclosed comprising: selecting, using a software dashboard graphical user interface, a predictive growth algorithm from a plurality of predictive growth algorithms; developing enterprise-specific revenue goals, employing code executed as a result of using the software dashboard graphical user interface, wherein the enterprise-specific revenue goals are based on the predictive growth algorithm which was selected; disaggregating the enterprise-specific revenue goals into subgoals for portions of the enterprise, using the software dashboard graphical user interface, wherein the portions of the enterprise correspond to input pipelines for the enterprise; evaluating data, employing code executed as a result of using the software dashboard graphical user interface, from the input pipelines corresponding to the subgoals; identifying one or more deficiencies in the data, employing code executed as a result of using the software dashboard graphical user interface, wherein the one or more deficiencies in the data are with respect to accomplishing one or more of the subgoals; and recommending, by the software dashboard graphical user interface, further action to correct the one or more deficiencies to achieve the one or more subgoals.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dashboard analysis using a computation engine for pipeline performance management.

FIG. 2 is a flow diagram for future output revenue extrapolation.

FIG. 3 is a system block diagram for output revenue analysis.

FIG. 4 is a block diagram for a marketing system.

FIG. 5A shows booking sources evaluation.

FIG. 5B shows net new bookings evaluation.

FIG. 6 illustrates an example dashboard.

FIG. 7 shows an example Sankey diagram.

FIG. 8 is a system diagram for dashboard analysis using a computation engine for pipeline performance management.

### DETAILED DESCRIPTION

Techniques for dashboard analysis and analytical planning using a computation engine for pipeline performance management are disclosed. An enterprise identifies and sells products and services to customers in order for the enterprise to survive. Certainly, the products and services must be appealing, desirable, and useful to the customers, but those qualities alone do not ensure that an existing product or service will continue to sell, nor do those qualities guarantee that a new product or service will sell well in a given market. Instead, the enterprise expends considerable financial and human resources identifying potential customers, and marketing products and services to these customers. The enterprise then works to convert the potential customers to actual customers. The conversion of potential customers can be based on online advertising, email and text campaigns, direct mail, telephone contacts, onsite presentations and demonstrations, etc. The enterprise further seeks to predict or forecast sales. Such predictions can be based on previous experience, historical sales data, predicted growth of a market or customer segment, and so on.

Revenue forecasting can be based on estimating future income, such as income from sales, by predicting a quantity of products or services that a sales unit can sell over a period of time. A sales unit can include a salesperson or a sales team; a department within, division of, or an entire enterprise; a marketing or demand generation team or campaign; and the like. The period of time can include a day, week, month, season, year, etc. The predicting can be based on analyzing historical data such as sales data to predict future sales. The historical data can indicate seasonal trends such as selling umbrellas in April or leaf rakes in September, and other seasonal variations. The historical data can further indicate which products and services were popular with customers and which were not. Such revenue forecasting can be applied when historical data has been collected and is available for analysis. However, when a product or service is new to the market or is substantially unique, or the enterprise is new enough to not have a sufficient amount of historical data (or any historical data), then predicting future sales based on historical data alone is not feasible.

One technique that can be useful for revenue forecasting, in the case where there is little or no historical sales data, can be based on applying benchmark revenue data from comparable products or services. The comparable products and services can be provided by the enterprise, by competitive enterprises, and so on. This technique can also consider seasonal variations in sales, changes in economic indicators, and the like. However, the historical data mentioned previously, and the benchmark revenue data may still not provide sufficient insight for providing revenue forecasts. Forecasts based on these datasets can miss key elements such as whether advertising campaigns are meeting sales objectives. Instead, a predictive growth algorithm can be selected for predicting future revenue. Enterprise revenue goals can be developed based on predicted growth, and the predicted growth can correspond to input pipelines. An input pipeline can be based on a visualization tool that can be used to illustrate the progress of potential customers through a sales technique or “pipeline”. The pipeline can be used to track progress, to indicate when an additional action or actions are required, etc.

Analysis of data such as sales data is accomplished by dashboard analysis using a computation engine for pipeline performance management. A predictive growth algorithm is selected from a plurality of predictive growth algorithms using a software dashboard graphical user interface. Enterprise-specific revenue goals employing code executed as a result of using the software dashboard graphical user interface are developed, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data from the input pipelines corresponding to the subgoals is evaluated employing code executed as a result of using the software dashboard graphical user interface. One or more deficiencies in the data are identified with respect to accomplishing one or more of the subgoals, employing code executed as a result of using the software dashboard graphical user interface. Further action is recommended by the software dashboard graphical user interface to correct for the one or more deficiencies and to achieve the one or more subgoals.

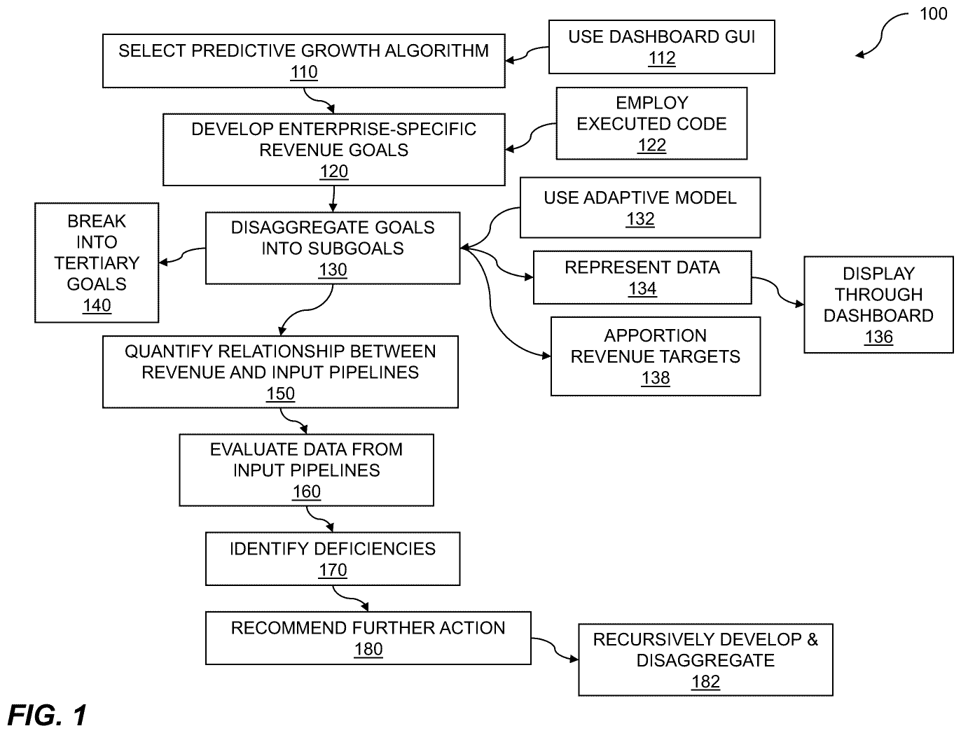

FIG. 1 is a flow diagram for dashboard analysis using a computation engine for pipeline performance management. Pipeline performance management can be utilized by a company, a consortium, an enterprise, and so on. A dashboard can include a visual representation of data rendered on a display associated with a personal electronic device, a computer, and so on. The flow 100 includes selecting a predictive growth algorithm 110 from a plurality of predictive growth algorithms. The predictive growth algorithms can be based on historical data, market trend analysis, economic factors, or simply realistic looking, initial assumptions, and so on. The predictive growth algorithms are not predicated on having prior company data. The predictive growth algorithms can be based on a normative growth model and/or a reference growth model. In embodiments, the predictive growth algorithm can be based on correlated data. The correlated data can include market condition parameters, industry codes (described below), and/or competitor performance data. Various types of analytical planning can be performed to enable better understanding of market directions and possibilities. Market condition parameters can include stock, bond, and commodities market conditions; energy market conditions; real estate conditions; and so on. The market conditions can include stable, volatile, etc.

In the flow 100, the selecting a predictive growth algorithm is accomplished using a software dashboard graphical user interface (SD-GUI) 112. The dashboard can present the visual representations of data as plots, graphs, pie charts, animations, text, and so on. The dashboard can be used to select code for execution. In embodiments, the predictive growth algorithm can be based on machine learning. The machine learning, which can include deep learning, can adapt or modify a predictive growth algorithm based on actual market performance, differences between predicted and actual data, and the like. In embodiments, the predictive growth algorithm can be based on a North American industry classification system (NAICS) code. A NAICS code can be used to classify an enterprise for the purposes of collecting data. Enterprises can be classified and separated into industries, where the industries can be defined by production processes. In other embodiments, the predictive growth algorithm can be based on a standard industrial code (SIC). An SIC is a 4-digit code assigned by the United States Government to enterprises to indicate a primary business of the enterprise. In other embodiments, the predictive growth algorithm can be based on competitor performance data. The competitor performance data can be based on competitor self reporting, industry analyst reporting, investment analyst reporting, and so on.

The flow 100 includes developing enterprise-specific revenue goals 120, wherein the enterprise-specific revenue goals are based on the predictive growth algorithm which was selected. The revenue goals can be based on performance targets such as sales or pipeline generation targets, strategic targets such as launching new products or services, and the like. The goals can include lead volume goals, sales opportunity volume or dollar amount goals, etc. The goals can be based on one or more datasets. In embodiments, the enterprise-specific revenue goals (and subgoals) can be based on previous business history. The previous business history can include sales data for one or more products, one or more services, and so on. The previous business history can take into account seasonal factors such as a holiday season, products or services used at specific times of year and not at other times, etc. In embodiments, the enterprise-specific revenue goals can be based on a database of quantified best practices. Quantified best practices can include proven or successful advertising techniques, email and text blasts, positive sales lead follow-up techniques, and the like. In the flow 100, the developing revenue goals is accomplished employing code 122 executed as a result of using the software dashboard graphical user interface. The code can be associated with a predictive growth algorithm, a heuristic, an application, and the like.

The flow 100 includes disaggregating 130 the enterprise-specific revenue goals into subgoals for portions of the enterprise using the software dashboard graphical user interface, wherein the portions of the enterprise correspond to input pipelines for the enterprise. An input pipeline can be based on one or more techniques that can be used to convert a prospective client or lead to a sale. An input pipeline can include a technique for converting a sales lead into an actual sale. An input pipeline can include visualization tools for sales progress, where sales progress can include a prospect becoming a qualified lead, indicating when a lead requires one or more follow-up actions, and so on. In embodiments, the pipeline input can include a leading indicator. A leading indicator can include data that can correspond to an event or phenomenon of interest such as impacts on sales, sales pipeline output, or marketing lead volumes. Leading indicators can include indexes such as sales activity levels like number of calls made or emails sent, online click-through rates, number of new online subscribers, etc. Successful conversion of a qualified lead to a customer can contribute to output income. In embodiments, the subgoals can be defined to enable accomplishment of the enterprise-specific revenue goals. The subgoals can include lead generation volume adjustments, online quantity promotions, and the like. The subgoals can include activities associated with the subgoals. In embodiments, the subgoals for portions of the enterprise can be based on previous business history. The previous business history can include lead conversion data, bookings data, revenue data, and so on. In embodiments, the subgoals for portions of the enterprise can be based on a database of quantified best practices. The best practices can include enterprise-dictated best practices, industry standard best practices, etc. In the flow 100, the disaggregating of the enterprise-specific revenue goals into subgoals for portions of the enterprise can be accomplished using an adaptive growth pipeline model 132. The disaggregating of the enterprise-specific revenue goals into subgoals for portions of the enterprise can be accomplished using an adaptive growth pipeline model that requires no prior actuarial data to create predictive growth plans. An adaptive growth pipeline model can be used to change, alter, update, etc., the pipeline model based on changing economic conditions. In a usage example, two online advertising services can be used to promote a product or service. More leads are generated by the second online advertising service than by the first service. The advertising campaign using the first service can be cancelled, while the second advertising campaign can be expanded. By changing the online advertising services used, increased sales leads can be generated.

The flow 100 further includes representing the data from the input pipelines, as well as the subgoals, in a graphical representation 134. The graphical representation can include one or more of a plot, a graph, a chart such as a pie chart, an animation, a text file, and the like. The graphical or other format can be chosen by the user to represent the data most conveniently. The flow 100 includes displaying the graphical representation through the dashboard graphical user interface 136. The SD-GUI can be rendered on a handheld device such as a smartphone or tablet, a laptop or desktop computer, etc. In embodiments, the representation can include a Sankey diagram (discussed below). The flow 100 further includes apportioning revenue targets 138, based on the enterprise-specific revenue goals, to components of the input pipelines for the enterprise based on the subgoals. The apportioning revenue targets can include increasing numbers of sales, promotional programs such as “buy one get one” (BOGO), loss leader programs, and the like. The flow 100 further includes breaking down the subgoals for the enterprise into tertiary goals 140 for the enterprise. The tertiary goals can be associated with a specific product or service, a particular enterprise segment, and so on. In embodiments, the tertiary goals for the enterprise can include targets for funnel points in between the input pipelines and output revenue. A target for a funnel point can include a number of lead conversions, follow-up activities, etc.

The flow 100 further includes quantifying a relationship 150 between the enterprise-specific revenue goals and the input pipelines for the enterprise, and using that quantifying to develop the subgoals for portions of the enterprise. The quantifying a relationship can include a value, a threshold, a percentage, and so on. The quantifying the relationship can be used to modify, adjust, or otherwise alter the relationship between the revenue goals and the input pipelines. Disclosed techniques enable the relationship between enterprise revenue goals and input pipelines to be quantified without prior data from the enterprise revenue or input pipelines being required. In embodiments, the quantifying the relationship between the enterprise-specific revenue goals and the input pipelines can be used in lead process refinement. As discussed previously, determining what aspects of one or more input pipelines are working effectively enables elimination or termination of a technique that is not working well, and continuation or expansions of a technique that is working well.

The flow 100 includes evaluating data 160, employing code executed as a result of using the software dashboard graphical user interface, from the input pipelines corresponding to the subgoals. The evaluating data can be used to determine or calculate progress of a pipeline toward attaining subgoals, goals, and so on. The evaluating data can be performed using a structured algorithmic comparison, such as a hashing comparison. The evaluating can include one or more business analytics techniques. In embodiments, three business data analytics techniques can include descriptive analytics, predictive analytics, and prescriptive analytics. Descriptive analytics can be used to identify what has happened previously with respect to lead generation, conversion and so on. Predictive analytics can be used to predict what could happen such as new product or service adoption, sales increases, market share expansion, and the like. Prescriptive analytics can be used to indicate what should happen with respect to success of products or services, sales increases, etc.

The flow 100 includes identifying one or more deficiencies 170, employing code executed as a result of using the software dashboard graphical user interface, in the data, with respect to accomplishing one or more of the subgoals. Deficiencies in data with respect to accomplishing one or more of the subgoals can include a deviation from progress toward attaining the one or more subgoals. In embodiments, the one or more deficiencies can include an underperformance on the one or more subgoals. An underperformance can include fewer generated leads; fewer potential client inquiries; poor response to advertising, email, and text campaigns; and the like. In other embodiments, the one or more deficiencies can include an overperformance on the one or more subgoals. An overperformance can include successful advertising, email, and text campaigns; increased potential client inquires; etc.

The flow 100 includes recommending, by the software dashboard graphical user interface, further action 180 to correct the one or more deficiencies to achieve the one or more subgoals. The recommending further action can include expanding outreach to potential clients, increasing follow-up actions, changing presentation styles or venues, and so on. In embodiments, the recommending further action can include enhanced focus on the overperformance on the one or more subgoals. The enhanced focus can include expanding overperforming advertising campaigns, email contacts, and text message outreach. In other embodiments, the further action to correct the one or more deficiencies can enable accomplishment of the enterprise-specific revenue goals. The further action to correct deficiencies can include frequent evaluation of data to identify deficiencies and frequent recommendations for further actions. The flow 100 further includes recursively 182 developing enterprise-specific revenue goals and disaggregating the enterprise-specific revenue goals into subgoals based on implementation of the further action. In embodiments, these subgoals comprise a plurality of subgoals. The success or failure of a further action can be used to enhance accuracy of goal development and subgoal disaggregation. The recursive development and disaggregation can be based on machine learning. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

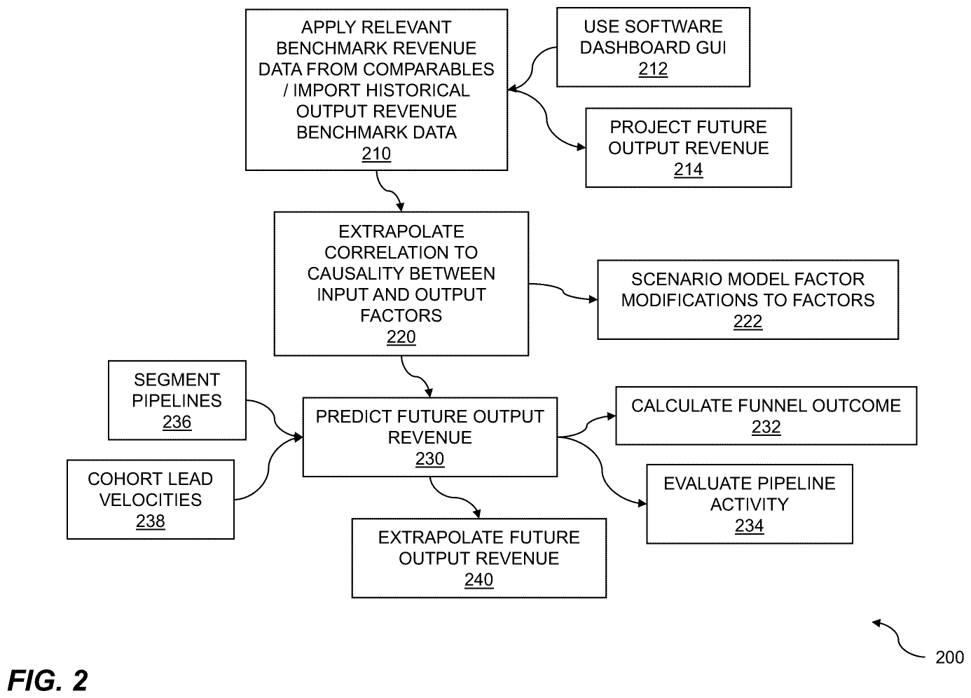

FIG. 2 is a flow diagram for future output revenue extrapolation. A value for future output revenue can be estimated or extrapolated based on one or more factors. A value for future output revenue can be based on a lead velocity rate, where a lead velocity rate can be based on real-time growth of qualified leads month over month. A value for future output revenue can be based on historical output revenue data. A value for future output revenue can be based on a predictive growth algorithm. Future output revenue extrapolation is based on dashboard analysis using a computation engine for pipeline performance management. Using a software dashboard graphical user interface, a predictive growth algorithm is selected from a plurality of predictive growth algorithms. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data is evaluated, employing code executed as a result of using the software dashboard graphical user interface, from the input pipelines which correspond to the subgoals. One or more deficiencies in the data, with respect to accomplishing one or more of the subgoals, are identified by employing code executed as a result of using the software dashboard graphical user interface. Further action is recommended, by the software dashboard graphical user interface, to correct the one or more deficiencies to achieve the one or more subgoals.

The flow 200 includes applying relevant benchmark revenue data from comparables and/or importing historical output revenue benchmark data 210. The relevant benchmark data from comparables can include data associated with comparable products and services offered by an enterprise, comparable products and services offered by a competitor, and so on. The benchmark data can include data from market trials. The benchmark data can be used when historical data is not available. The historical data can include data from a previous version of a product or service, previous sales of the current product or service, etc. In a usage example, a new company has developed a product and has readied it for sale. The new company does not have historical data, so must estimate sales based on competitor products, test sales, product research, and the like. In a second usage example, an established company has a new product for sale. Sales estimates for the new product can be based on sales of various versions of the product, similar products offered by the enterprise, etc. The flow 200 can include using a software dashboard 212 graphical user interface. The software dashboard can be presented on a personal electronic device, a laptop or desktop computer, and so on. The flow 200 includes using that historical output revenue data for projecting future output revenue 214 based on the further action that was recommended. Discussed previously and throughout, a further or corrective action, such as dropping an unsuccessful advertising campaign, expanding a successful campaign, etc. can be recommended.

The flow 200 includes extrapolating from correlation to causality 220 between a factor from output revenue and a factor from the pipeline input. The correlation can include an increased number of leads, a type of lead, a bump in sales following an advertising campaign, and so on. In embodiments, a factor from the pipeline input includes a lead flow. A lead flow can include an explanation for a steady flow of leads, a bump in a number of leads, and the like. A lead flow can include a lead conversion path. In a usage example, a lead conversion path can include a technique for converting visitors to a website such as an enterprise website to leads. In other embodiments, a factor from the output revenue includes a lead velocity. A lead velocity can include calculating lead growth in a duration of time. In a usage example, the lead velocity can calculate lead growth month over month. In embodiments, the factor from the input pipelines includes lead stage definitions, lead flows, and lead velocities. The flow 200 further includes scenario modeling 222 of modifications to a factor from the input pipeline. Scenario modeling can include techniques that can modify input pipeline factors such as numbers of and placement of advertisements such as online advertisements, content and frequency of email and text solicitations, etc.

The flow 200 includes predicting 230 the future output revenue. The predicting can be based on applying relevant benchmark revenue data from comparables, analyzing historical output revenue data, and so on. The predicting the output revenue can be based on a predictive growth algorithm that can be selected. In embodiments, the predictive growth algorithm can be based on market condition parameters. Market condition parameters can include stock and bond market conditions, real estate conditions, and so on. The market conditions can include stable, volatile, etc. In other embodiments, the predicting the output revenue can be accomplished using machine learning. The flow 200 includes calculating a funnel outcome 232 based on the input pipelines. A sales funnel can include one or more levels, stages, and so on, such as a marketing stage, follow-up, a sales process, and the like. In embodiments, the funnel outcome can be used in the predicting an output revenue. The funnel outcome can include net new bookings. In other embodiments, the funnel outcome can include a lagging indicator. A lagging indicator can include a labor cost, an unemployment rate, a corporate profits rate, etc. The flow 200 includes evaluating a pipeline generation activity 234 for impact on the output revenue. Pipeline generation activity can be based on successful marketing activities such as advertising, email, and text (SMS) campaigns. The pipeline generation activity can be based on sales activities such as presentations and events, on-site presentations, personal contacts, etc.

The flow 200 further includes segmenting the input pipelines 236 and using that segmenting in predicting the output revenue. The segmenting can include partitioning potential customers, leads, etc. into segments. The segments can be based on demographic data such as age, gender, geographic location, race, creed, and so on. The flow 200 further includes cohorting 238 different lead progress velocities across stages of business development, between the input pipelines and output, for impacts on output revenue. The cohorting can be based on likelihood that a lead will convert, a potential sales amount, a client company size, and so on. The flow 200 further includes extrapolating a future output revenue 240 based on the further action being implemented. The extrapolating can be based on setting goals, measuring progress toward achieving goals, suggesting corrections to improve goal attainment, and so on. The extrapolating can be particularly useful in the absence of historical output revenue data since corrections to marketing and sales techniques can be suggested “on the fly”. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

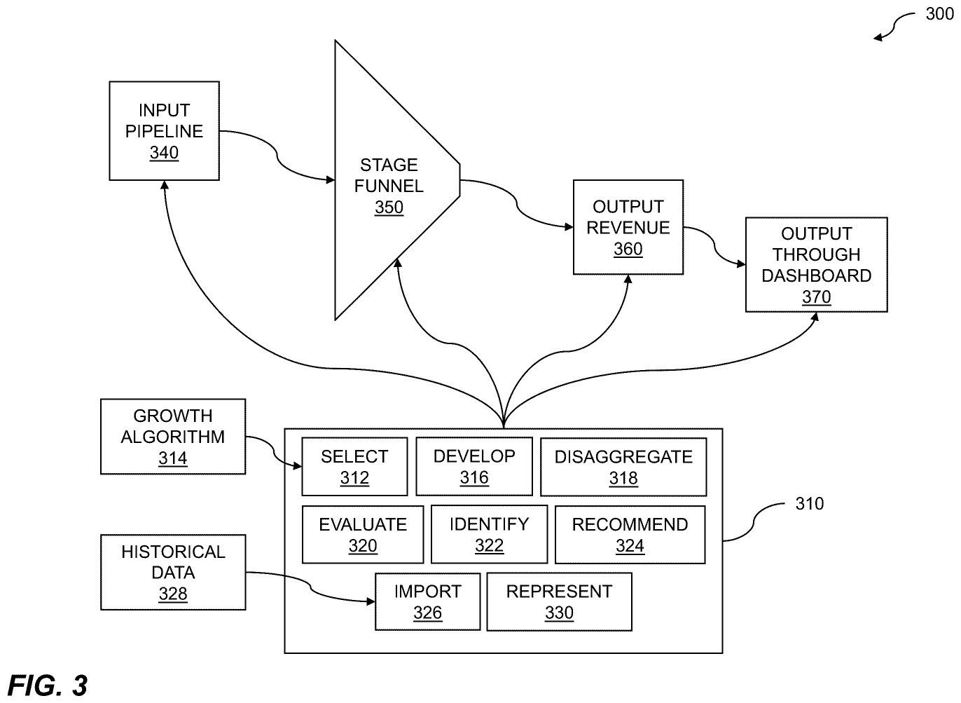

FIG. 3 is a system block diagram for output revenue analysis. Output revenue analysis can be based on one or more input pipelines. An input pipeline can be based on one or more techniques that can be used to convert a prospective client or lead to a sale. An input pipeline can include visualization tools for sales progress, where sales progress can include a prospect becoming a qualified lead, indicating when a lead requires one or more follow-up actions, and so on. Successful conversion of a qualified lead to a customer can contribute to output income. Output revenue analysis is based on dashboard analysis using a computation engine for pipeline performance management. Using a software dashboard graphical user interface, a predictive growth algorithm is selected from a plurality of predictive growth algorithms. Enterprise-specific revenue goals are developed, employing executed code. The enterprise-specific revenue goals are based on the selected predictive growth algorithm. The enterprise-specific revenue goals are disaggregated into subgoals for portions of the enterprise, using the software dashboard graphical user interface. The portions of the enterprise correspond to input pipelines for the enterprise. Executed code is employed to evaluate data from the input pipelines corresponding to the subgoals. Code is executed to identify one or more deficiencies in the data with respect to accomplishing one or more of the subgoals. The dashboard is used to recommend further action to correct the one or more deficiencies so as to achieve the one or more subgoals.

The block diagram 300 can include a computation engine 310. The computation engine can be used to support the software dashboard graphical user interface (SD-GUI), to execute predictive growth algorithms, to disaggregate revenue goals, to evaluate data, and so on. The computation engine can be based on one or more computers, processors, processor cores within integrated circuits, and so on. The computation engine can include one or more components that can enable pipeline performance management. The block diagram can include a selection component 312. The selector can be used to select a predictive growth algorithm from a plurality of predictive grown algorithms 314. The selected predictive growth algorithm can be used to make sales and growth predictions based on growth indicators. Growth indicators can be based on gross domestic product (GDP), household income, sales of types of products, etc. The block diagram can include a development component 316. The development component can be used to develop enterprise-specific revenue goals. The enterprise specific revenue goals can be based on predictions made by the selected predictive growth algorithm. The block diagram can include a disaggregation component 318. The disaggregator disaggregates enterprise-specific revenue goals into subgoals. The subgoals can be associated with portions of the enterprise. The portions of the enterprise can correspond to one or more input pipelines. The input pipelines corresponding to the subgoals can employ a lead source correspondence, a calculated budget correspondence, a manually entered correspondence, and so on.

The block diagram can include an evaluation component 320. The evaluator can evaluate data from one or more input pipelines. The one or more input pipelines can correspond to one or more enterprise-specific revenue subgoals. The evaluation can include the probability that a prospect can become a qualified lead, can indicate what follow-up actions can be required to assist with conversion, can show which qualified lead became a booking, and so on. The block diagram can include an identification component 322. The identifier can identify one or more deficiencies in data. The deficiencies can be associated with one or more of the subgoals for portions of the enterprise. A “deficiency” can be thought of as a difference or delta from an expected value determined by the predictive growth algorithm. In a usage example, two advertising platforms are engaged to provide online advertisements to prospective customers. The advertisements provided by the first platform are performing poorly by attracting few prospective customers, while the advertisements provided by the second platform are performing very well. By identifying which advertising campaigns are performing poorly and which are performing well, the poorly performing advertisements can be dropped while the well performing advertisements can be continued and expanded.

The block diagram can include a recommending component 324. The recommender can recommend one or more further actions that can be taken to correct one or more deficiencies. The recommender can suggest actions such as cancelling an unsuccessful advertising campaign, continuing or expanding a successful campaign, recommending a number of follow-up email or text messages and the content of those messages, offering a discount if the potential customer converts within a timeframe, etc. The block diagram can include an importation component 326. The importer can import data, where the imported data can be used to project further output revenue. The data that can be imported can include projected data, estimated data, and so on. The data that is imported can include historical data 328. Embodiments can include importing historical output revenue data, using a software dashboard graphical user interface. The historical output revenue data can be used for projecting future output revenue based on the further action that was recommended. The block diagram can include a representing component 330. The representor can provide a graphical representation of a variety of datasets. The datasets can include data from an input pipeline, data from an output pipeline, and so on. Embodiments can include representing the data from the input pipelines as well as the subgoals. The data can be represented in a graphical representation. The graphical representation can be displayed through the dashboard graphical user interface. The representation can include a graph, a pie chart, a table, and so on. In embodiments, the representing can include a Sankey diagram.

The computation engine can be used to control further components of the block diagram, to evaluate data, and so on. The block diagram can include an input pipeline 340. An input pipeline can include one or more stages, where the stages can include research, available options or solutions, cost-benefit analysis, and so on. The input pipeline can include identifying potential leads. A sales pipeline can enable progress through the one or more stages of a sale, can declare a potential sale lost, etc. The block diagram can include a stage funnel 350. The stage or sales funnel, which can be based on one or more stages, can be used to advance individuals and enterprises from “cold” sales prospects based on generated leads, to shepherd prospects through a sales technique, to offer additional goods and services (e.g., upselling), etc. The block diagram can include output revenue 360. The output revenue can include estimates based on bookings, income received from sales, and so on. The block diagram can include output through a software dashboard 370 graphical user interface. The output can include recommending further action to correct one or more deficiencies that can be identified.

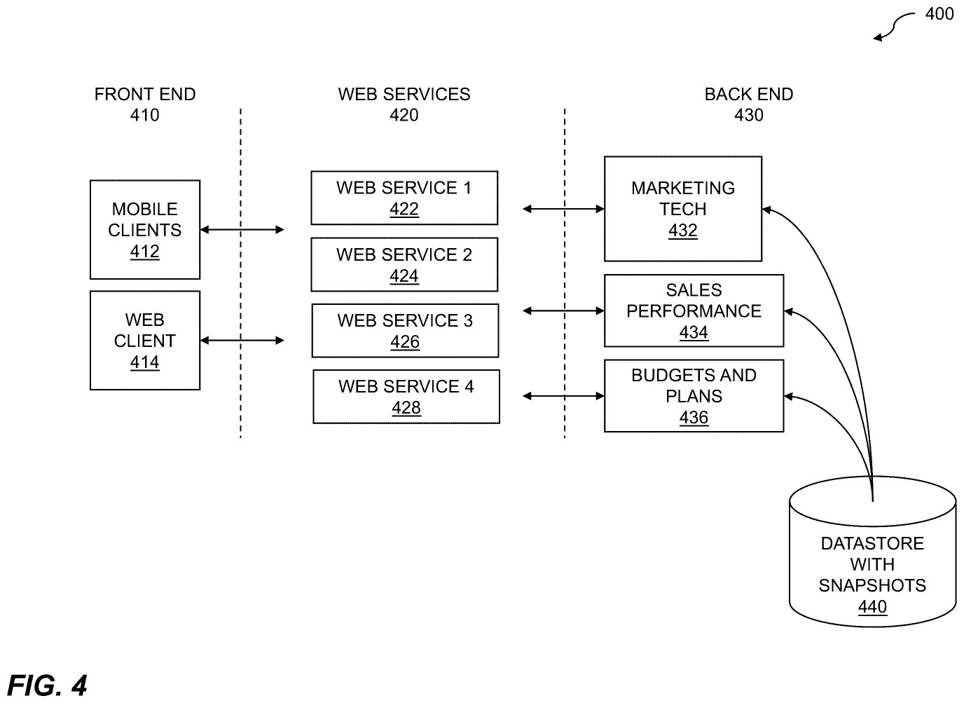

FIG. 4 is a block diagram for a marketing system. An enterprise can choose to serve a particular market portion or vertical. The vertical can be based on a particular type of product or service, a customer base, and so on. One advantage of choosing a vertical is that marketing and other communications can be better tuned and tailored to the clients and customers associated with the vertical. The marketing can be accomplished using a marketing system. The marketing system is based on dashboard analysis using a computation engine for pipeline performance management. Using a software dashboard graphical user interface, a predictive growth algorithm is selected from a plurality of predictive growth algorithms. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data is evaluated, employing code executed as a result of using the software dashboard graphical user interface, from the input pipelines corresponding to the subgoals. One or more deficiencies in the data, with respect to accomplishing one or more subgoals, are identified by employing code executed as a result of using the software dashboard graphical user interface. Further action is recommended, by the software dashboard graphical user interface, to correct the one or more deficiencies to achieve the one or more subgoals.

A block diagram for a marketing system is illustrated 400. The marketing system can be used by an enterprise to show their products and services, provide demonstrations, enable information gathering, and so on. The marketing system can be used by the enterprise to engage with existing clients and customers, attract new clients and customers, develop leads, etc. The marketing system can be the first “port of call” or contact that an enterprise can have with a potential lead. The marketing system can be designed to engage visitors to the system and to convert the visitors to clients and customers. The marketing system can include a front-end portion 410. The front end can be the outward facing portion of the marketing system by providing information to and engaging existing clients, attracting leads, and so on. The front end can be accessible over the Internet. Access to the front end can be accomplished using one or more mobile clients 412. The mobile clients can include apps associated with an enterprise, where the apps can be installed on a personal electronic device such as a smartphone, tablet, or PDA. The mobile app can be provided by the enterprise through an application store such as the Apple™ App Store™, the Google™ Play™ app store, and so on. Access to the front end 410 can further be accomplished through a web client 414. The web client can include a web browser application such as Chrome™, Edge™, Firefox™, Opera™, Safari™, etc. A current client or potential client can use an application on their electronic device to access a website provided by the enterprise.

The marketing system can include one or more web services 420. The web services can include web service 1 422, web service 2 424, web service 3 426, web service 4 428, and so on. The one or more web services can accomplish a variety of tasks such as customer relationship management (CRM). CRM services can enable an enterprise to store current and prospective customer data, manage marketing campaigns, identify sales opportunities, record and track service issues, and so on. The web services such as web service 1, web service 2, web service 3, web service 4 can include CRM services provided by multiple vendors. The web services can further include enterprise resource planning (ERP). ERP can enable an enterprise to perform management of day-to-day operations of the enterprise. The operations can include accounting, procurement, risk management and compliance, project management, and the like. ERP can further enable an enterprise to manage financial results by supporting planning, budgeting, and predicting, and reporting results. Data associated with ERP can be saved in a datastore (described below).

The marketing system can include a back end 430. The marketing system back end can include tools for outreach, sales, budgeting, and so on. The back end can include marketing technology 432 or “martech” techniques. Marketing technology can be used to plan, execute, track, and measure marketing campaigns. The martech techniques can include techniques for reaching and engaging an intended audience for the marketing campaign. The back end can include sales performance 434 techniques. The sales performance techniques can include marketing and sales intelligence data, lead prospecting and handling, business analytics and reporting, and processing and training. The sales performance techniques can further include automation and integration techniques. The back end can further include budgeting and planning techniques 436. The budgeting and planning techniques can include estimating sales and other income, estimating when the income is likely to be available, planning a budget to remain within available funds, and so on. The back end can further include a datastore with snapshots 440. The datastore can store data associated with marketing technology management, sales performance, and budgets and planning. The datastore can further include snapshots. The snapshots can include market snapshots. The market snapshots can summarize current market activity in one or more marketing areas.

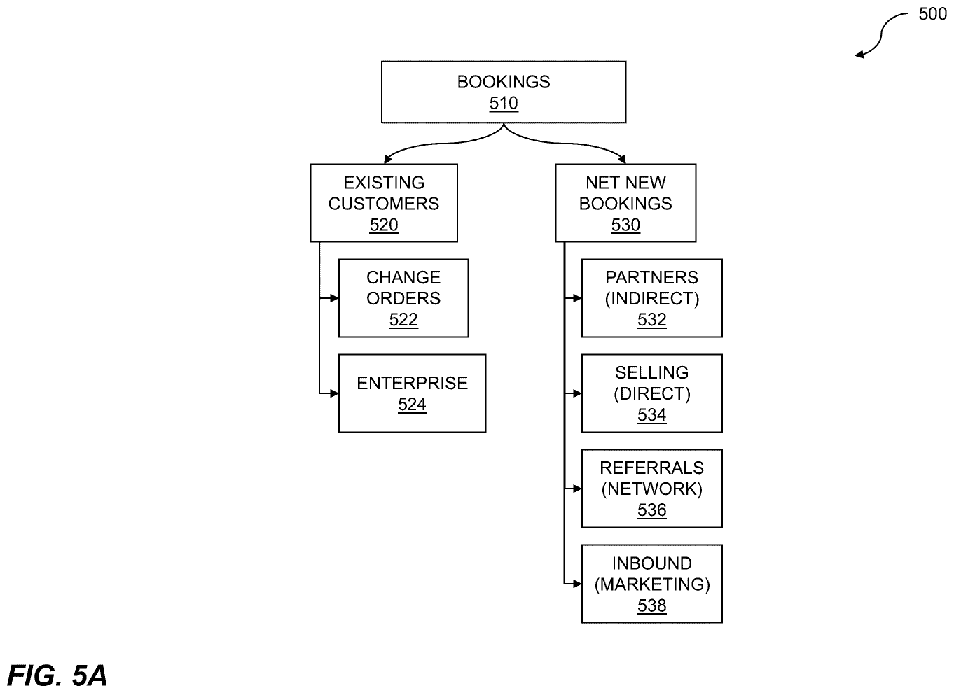

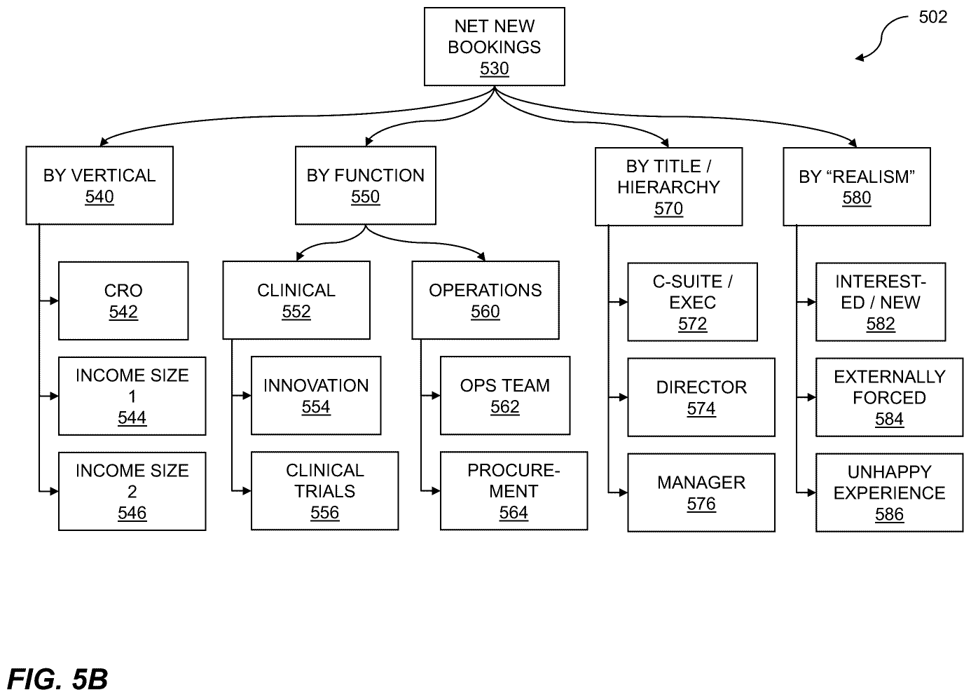

FIG. 5A shows booking sources evaluation. An enterprise desires to drive growth in sales, contracts, manufacturing, and so on. The growth can be driven by precisely targeting a particular client segment. A client segment can be based on a business vertical, a business function, a client position within an organization, the likelihood of conversion, and so on (discussed shortly in FIG. 5B). A business vertical can include a niche market in which a business has focused its products, marketing strategies, and the like. Business bookings are based on commitments made by customers to buy a good or service. The bookings can be displayed within the software dashboard graphical user interface (SD-GUI). Booking sources evaluation supports dashboard analysis using a computation engine for pipeline performance management. Using a software dashboard graphical user interface, a predictive growth algorithm is selected from a plurality of predictive growth algorithms. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data is evaluated, employing code executed as a result of using the software dashboard graphical user interface, from the input pipelines corresponding to the subgoals. One or more deficiencies in the data, with respect to accomplishing one or more of the subgoals, are identified, by employing code executed as a result of using the software dashboard graphical user interface. Further action is recommended, by the software dashboard graphical user interface, to correct the one or more deficiencies to achieve the one or more subgoals.

The example diagram shows booking sources evaluation 500. A user can choose to view booking sources within the SD-GUI by clicking, tapping, or otherwise selecting a bookings 510 icon displayed within the SD-GUI. The bookings can include existing or current customers 520, net new bookings 530, prior or lapsed customers (not shown), and so on. Each category or type of customer can be partitioned into or assigned to a number of subcategories. The subcategories can be displayed by selecting a category, by selecting a subcategory within the category, and so on. In the example, the existing customers category 520 can include example subcategories such as change orders 522, an enterprise affiliation 524, and the like. The net new bookings category 530 can include subcategories such as partners (indirect sales) 532, selling (direct sales) 534, referrals (through network) 536, inbound (from marketing) 538, etc. Other net new bookings can include web inquiries, personal contacts, trade shows, etc.

FIG. 5B shows net new bookings evaluation 502. Discussed previously, the software dashboard graphical user interface (SD-GUI) can be used to present booking information. The booking information can include bookings associated with existing customers; net new bookings; former, inactive, or lapsed customers; and so on. The net new bookings can be further rendered based on a targeted new business segment. Selecting the targeted new business segment can enable a user to observe greater detail associated with a new booking. The targeted new business segment can include a business vertical, a business or enterprise function, a position within an enterprise, a “realism” factor (e.g., how likely is a lead to convert), and so on. Net new bookings evaluation supports dashboard analysis using a computation engine for pipeline performance management.

The software dashboard GUI enables a user to view various categories and subcategories associated with net new bookings 530. The subcategories associated with the net new bookings can be associated with various business segments. Example business segments are shown. In the FIG. 502, the business segments can be viewed by business vertical 540. A business vertical can be a business niche selected by an enterprise. The business vertical can include a substantially specialized product or service, a product or service optimized by an enterprise to serve the business vertical, and so on. The business vertical can also be selected to target the needs of a set of customers. A business vertical icon within the SD-GUI can be selected to reveal one or more verticals. In the example, the business verticals can include conversion rate optimization (CRO) 542. CRO can include optimizing an enterprise website based on behavior of visitors to an enterprise website. The objective of CRO can include improving user experience (UX) with the website to help “convert” the user. User conversion can include the user purchasing a good or service. Business vertical subcategories can include enterprise income size such as income size 1 544, income size 2 546, and so on. The income size can include a small, medium, or large size enterprise, an international enterprise, etc.

The FIG. 502 can include one or more business segments based on function 550. The function can include a function served by the enterprise. In the example, the function can include a clinical 552 function. The clinical function can be associated with an enterprise such as a drug company. Under the clinical function, subcategories can include innovation 554, clinical trials 556, and so on. The innovation function can include identifying, developing, inventing, etc., new products. The clinical trial's function can include testing new products, modified products, and so on. The example can further include functions based on operations 560 associated with the enterprise. The operations can include an operations team 562. The operations team can include a team responsible for a specific good or service, an enterprise level operations team, and so on. Other activities associated with an enterprise can be categorized as operations. In the example, the operations can include procurement 564. Procurement can include individual contacts within an enterprise procurement department or the department.

The business segments can be based on contact title or hierarchy 570 within an enterprise. A contact can include a contact who has purchased goods and services previously, who has the authority to choose and approve vendors and to sign off on purchase agreements, and so on. Various enterprise employees can be viewed within this category. The enterprise personnel who can fit into this business segment can include “C-suite” and executive level 572 employees, contacts, etc. C-suite employees can include the Chief Executive Officer (CEO), Chief Financial Officer (CFO), Chief Operating Officer (COO), Chief Technology Officer (CTO), etc. The enterprise personnel can further include one or more directors 574. A director can include a corporate board member, a department or section director, and so on. The enterprise personnel can further include one or more managers 576. The managers can include group managers, line managers, and the like.

The SD-GUI can further include a category for targeted business segments based on “realism” 580. Realism can be based on one or more factors that can enable conversion of a potential lead to a new booking. In the example, the realism can be based on a level of interest or a new customer 582. A lead who engages with an enterprise website by filling out a web form, contacting sales or customer service representatives, and so on may have a higher probability of conversion than a website visitor who browses the site but does not further engage with the site. Realism can further be based on a lead being externally forced 584 to engage with an enterprise. The external force can include legislative requirements such as data storage and integrity, security measures, and the like. Realism can also be based on a lead having an unhappy experience 586 with another enterprise. The unhappy experience can be based on a product or service not performing as promised, failure to meet contractual obligations, etc.

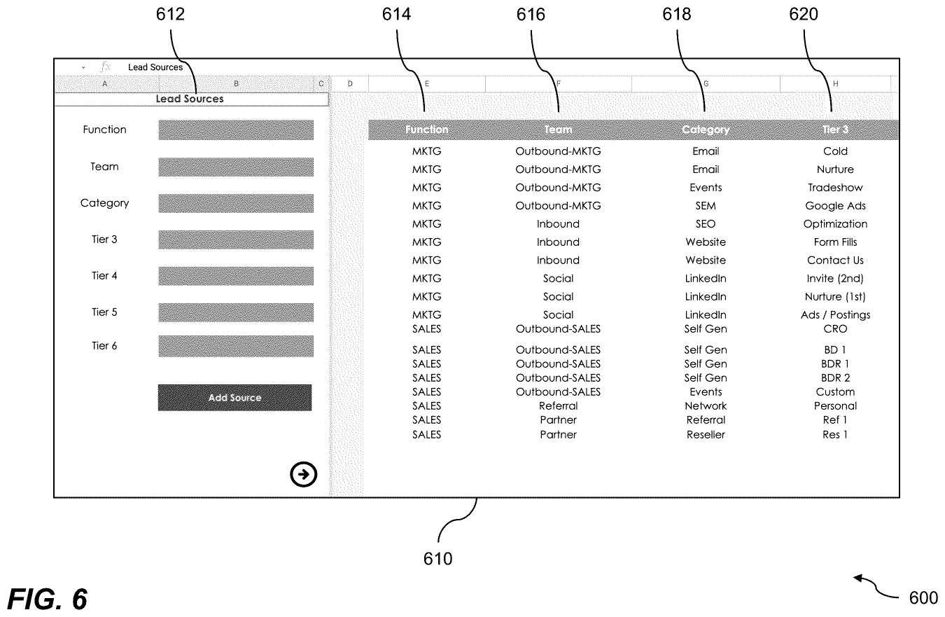

FIG. 6 illustrates an example dashboard. A dashboard is a type of graphical user interface in which data can be presented. The dashboard, which can be analogous to an instrument cluster on a dashboard of a vehicle, can render a variety of data sources in visually appealing, easily understood formats. The data presented on the dashboard can include gauges, graphs, charts, text, and so on. A dashboard graphical user interface enables analysis using a computation engine for pipeline performance management. Using a software dashboard graphical user interface, a predictive growth algorithm is selected from a plurality of predictive growth algorithms. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data is evaluated, employing code executed as a result of using the software dashboard graphical user interface, from the input pipelines corresponding to the subgoals. One or more deficiencies in the data are identified, with respect to accomplishing one or more of the subgoals, by employing code executed as a result of using the software dashboard graphical user interface. Further action is recommended, by the software dashboard graphical user interface, to correct the one or more deficiencies and to achieve the one or more subgoals.

An example software dashboard graphical user interface (SD-GUI) 600 is illustrated. The SD-GUI can be displayed within a window such as window 610, a frame, a subframe and so on. The window, for example, can be presented on a display associated with an electronic device. The electronic device can include a smartphone, tablet, laptop computer, desktop computer, and so on. The dashboard within the window can be used to present information, menus, buttons, and so on. The dashboard for pipeline performance management can include lead sources 612. The lead sources can include sales leads. Sources other than leads, such as potential collaborators, emerging technologies, and so on, could be displayed here. The lead sources can vary based on a given enterprise. In the example, the lead sources can include a function (described shortly below), a team, a category, one or more tiers, and so on. The list presented under sources can be modified. Sources can be added, deleted, edited, etc. Data associated with any of the lead sources can be viewed by selecting one lead source. The dashboard can include a function 614. In the example, the function can include marketing and sales. Other functions might include recovery or savage, recycle, etc. The dashboard can include a team 616. The team can include an enterprise team that can be responsible for a function, a portion of a function, and the like. In the example, the team can include outbound marketing, an inbound query, a social media source, outbound sales, a referral, a partner, etc.

The dashboard can include a category 618, where the category can include a category associated with a team. In the example, a category can include an outbound email message sent by marketing; events organized by marketing; search engine marketing (SEM); search engine optimization (SEO); a website such as an enterprise website; a social network such as Facebook™, LinkedIn™, Instagram™, etc.; self-generated sales; events organized by sales; referrals; resellers; and so on. SEO differs from SEM. SEO uses search engine tricks such as embedded keywords that get picked up by search engines. The search engines see the keywords and, as a result, place the webpage higher (ideally at the top) of the search results. SEM, by contrast, uses paid methods to raise a website in search results. The dashboard can also include tiers 620. In the example, one tier, Tier 3, is shown. The tier can be used to include further data such as a quality of a lead, the source of the lead, follow up instructions, etc. In the example, the data in Tier 3 can include cold (unlikely), nurture (needs development), a trade show, an ad such as a Google Ad™ or a LinkedIn Ad™, fill-in webform data, “contacted us” (lead contacted enterprise), an invitation, a custom sales event such as an on-site presentation, a personal contact, a referral, a reseller, etc.

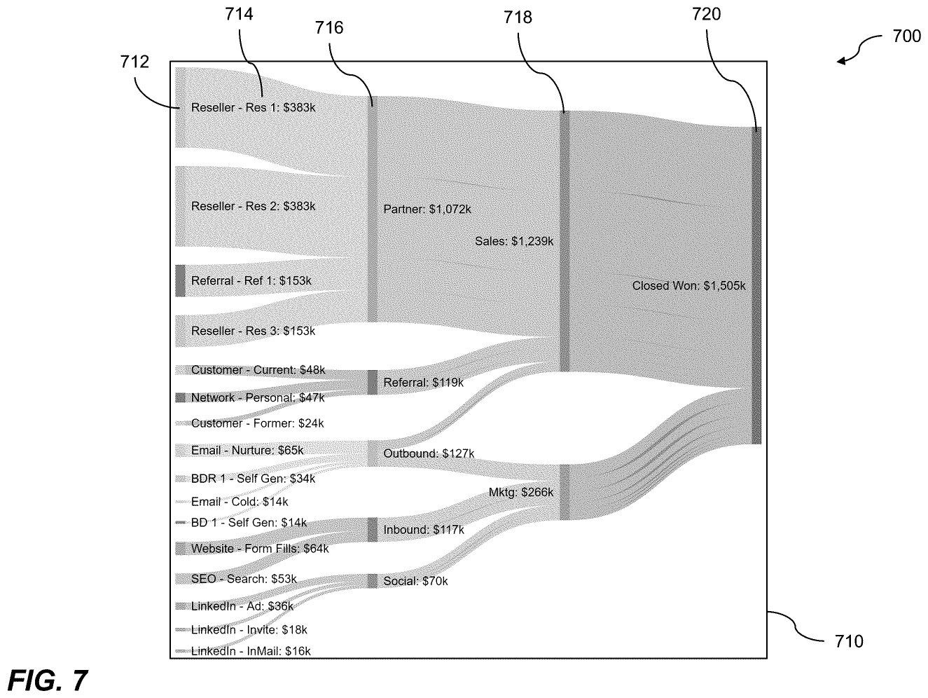

FIG. 7 shows an example Sankey diagram 700. A Sankey diagram can be used to visualize domains of data. Data domains can include existing customers, advertising and outreach campaigns, generated leads, and so on. Another data domain can include estimated revenue, signed contracts, won deals, and the like. A Sankey diagram is based on nodes that are connected by links. The nodes and links can be associated with input pipelines for an enterprise. The sizes of the nodes and the links can illustrate relative sizes or contributions of input pipelines associated with the nodes and links. The larger a node and link, the larger the contribution of the node and link. Sankey diagrams enable dashboard analysis using a computation engine for pipeline performance management. Using a software dashboard graphical user interface, a predictive growth algorithm is selected from a plurality of predictive growth algorithms. Enterprise-specific revenue goals are developed, employing code executed as a result of using the software dashboard graphical user interface, wherein the enterprise-specific revenue goals are based on the predictive growth algorithm which was selected. The enterprise-specific revenue goals are disaggregated into subgoals for portions of the enterprise, using the software dashboard graphical user interface, wherein the portions of the enterprise correspond to input pipelines for the enterprise. Data is evaluated, employing code executed as a result of using the software dashboard graphical user interface, from the input pipelines corresponding to the subgoals. One or more deficiencies in the data are identified, with respect to accomplishing one or more of the subgoals, by employing code executed as a result of using the software dashboard graphical user interface. Further action is recommended, by the software dashboard graphical user interface, to correct the one or more deficiencies to achieve the one or more subgoals.

The example Sankey diagram comprises nodes and links. A node can represent an input pipeline, where an input pipeline can represent how a customer, client, buyer, and so on moves through a funnel such as a sales funnel. A node can represent revenue from a variety of sources. In the Sankey diagram 710, a node 712 can represent a reseller 714. Other nodes can be included in the diagram, where the other nodes can represent one or more additional resellers, one or more referrals, and so on. Nodes can further be associated with current customers, personal contacts made through a network, former customers, email and text solicitations, website forms, advertisements, etc. Links between a subset of input nodes can be directed to one or more further nodes within the Sankey diagram, such as a partner node 716. Further links can be made between current customers, former customers, and referrals to a referral node; email and other outreach to an outbound node; and so on. Further links can be made between nodes, such as links from partner, referral, and outbound nodes to a sales node 718. The links can further connect the sales node 718 and the marketing node to a closed/won node 720. The closed/won node can represent closed deals, won contracts, completed sales, etc.

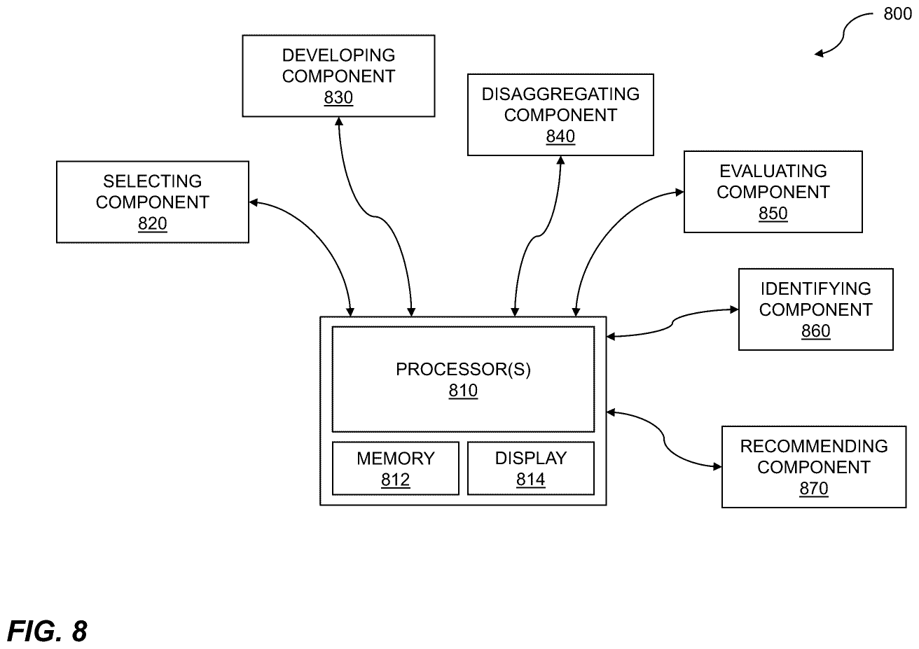

FIG. 8 is a system diagram for analysis. The analysis is enabled by dashboard analysis using a computation engine for pipeline performance management. The system 800 can include one or more processors 810, which are attached to a memory 812 which stores instructions. The system 800 can further include a display 814 coupled to the one or more processors 810 for displaying data; intermediate steps; predictive growth algorithms, enterprise-specific revenue goals, subgoals, and tertiary goals; identified deficiencies; recommendations; and so on. In embodiments, one or more processors 810 are coupled to the memory 812, wherein the one or more processors, when executing the instructions which are stored, are configured to: select, using a software dashboard graphical user interface, a predictive growth algorithm from a plurality of predictive growth algorithms; develop enterprise-specific revenue goals, employing code executed as a result of using the software dashboard graphical user interface, wherein the enterprise-specific revenue goals are based on the predictive growth algorithm which was selected; disaggregate the enterprise-specific revenue goals into subgoals for portions of the enterprise, using the software dashboard graphical user interface, wherein the portions of the enterprise correspond to input pipelines for the enterprise; evaluate data, employing code executed as a result of using the software dashboard graphical user interface, from the input pipelines corresponding to the subgoals; identify one or more deficiencies in the data, employing code executed as a result of using the software dashboard graphical user interface, wherein the one or more deficiencies in the data are with respect to accomplishing one or more of the subgoals; and recommend, by the software dashboard graphical user interface, further action to correct the one or more deficiencies to achieve the one or more subgoals.

The system 800 can include a selecting component 820. The selecting component 820 can select, using a software dashboard graphical user interface, a predictive growth algorithm from a plurality of predictive growth algorithms. A software dashboard graphical user interface (SD-GUI) can include one or more views of one or more components of a business process. Much like an instrument cluster in a vehicle, the SD-GUI can present graphical representations of key performance indicators (KPIs). The SD-GUI can be used to display progress, delays, “pressure points”, discrepancies, and the like. A predictive growth algorithm can be based on a predictive growth model. The predictive growth model can use known results, historical results, and the like to create, process, and validate a model. The predictive growth model can be used to predict future revenue. The predicted future revenue can be based on predicting or forecasting events, customer behavior, and risks, where the risks can include economic, financial, and market risks, etc. In embodiments, the predictive growth algorithm can be based on machine learning. The machine learning can be used to adjust the predictive growth model to improve accuracy, convergence, and so on. In embodiments, the predictive growth algorithm can be based on a NAICS industry code. The North American Industry Classification System can be used by Federal statistical organizations to classify businesses based on statistical data associated with the United States economy. In other embodiments, the predictive growth algorithm can be further based on a standard industry code (SIC). The SIC can describe the primary business activity associated with a company. In further embodiments, the predictive growth algorithm can be based on market condition parameters. The market condition parameters can influence a market. Market condition parameters can include number of competitors, demand, available inventory, intensity of competition, etc.

The system 800 can include a developing component 830. The developing component 830 can develop enterprise-specific revenue goals, employing code executed as a result of using the software dashboard graphical user interface, wherein the enterprise-specific revenue goals are based on the predictive growth algorithm which was selected. The enterprise can include any of a variety of enterprises such as retail, financial, healthcare, and so on. The predictive growth model can be used to develop revenue goals based on building market share, entering new markets, identifying new customer groups, and the like. The system 800 can include a disaggregating component 840. The disaggregating component 840 can disaggregate the enterprise-specific revenue goals into subgoals for portions of the enterprise, using the software dashboard graphical user interface, wherein the portions of the enterprise correspond to input pipelines for the enterprise. In a usage example, an enterprise can work with two or more resellers, can receive referrals, etc. Subgoals can be associated with each reseller, each referral source, and the like. The subgoals can be based on an input pipeline associated with an enterprise. A pipeline can describe progress toward a goal such as a long-term goal, where progress toward the goal is based on distinct or discrete stages. The stages can include research such as industry research, lead generation, contract or other negotiations, due diligence, execution or acquisition, and so on. Embodiments further include quantifying a relationship between the enterprise-specific revenue goals and the input pipelines for the enterprise, and using that quantifying to develop the subgoals for portions of the enterprise.

The system block diagram 800 can include an evaluating component 850. The evaluating component 850 can evaluate data, employing code executed as a result of using the software dashboard graphical user interface, from the input pipelines corresponding to the subgoals. The data can include costs such as costs of materials, advertising, outreach, etc.; pricing information; estimated unit sales; and so on. The data can include potential leads, target business segments, tailoring of messaging, etc. The data can include historical data from previous campaigns, performance-to-date data in lieu of historical data, and the like. The historical data can provide some guidance into which segment targeting, messaging, and so on, has been effective previously. When historical data is unavailable, such as for a startup enterprise, then frequent data evaluation can enable rapid corrections to attain subgoals, and by extension, an overall goal.

The system 800 can include an identifying component 860. The identifying component 860 can identify one or more deficiencies in the data, with respect to accomplishing one or more of the subgoals, by employing code executed as a result of using the software dashboard graphical user interface. A deficiency can include a deviation from an expected or projected value associated with a subgoal, where the deviation can include negative performance or underperformance, positive performance or overperformance, etc. The deficiency can be neutral, indicating that a subgoal is being met. In the case of underperformance, corrective action can be taken to improve performance toward achieving a subgoal. Conversely, if overperformance is detected, then the company can continue with or do more of that overperforming technique. The identifying can be used to make one or more adjustments to one or more subgoals (discussed below). In a usage example, messaging campaigns can be undertaken using two advertising platforms. Data obtained from the evaluation can identify that one messaging campaign is underperforming while the second is overperforming with respect to attaining a subgoal. In the case of an underperforming messaging campaign, the messaging can be changed, or the campaign eliminated. In the case of an overperforming messaging campaign, the campaign can be continued unchanged or can be expanded.

The system 800 can include a recommending component 870. The recommending component 870 can recommend, by the software dashboard graphical user interface, further action to correct the one or more deficiencies to achieve the one or more subgoals. Discussed above and throughout, a further action can include revising or eliminating a technique, procedure, program, etc. that is underperforming; expanding a technique that is overperforming; and so on. The recommended further action can be based on advancing progress toward one or more subgoals, a goal, etc. The recommended action can be applied to an input pipeline. Further embodiments can include predicting a future output revenue based on one or more incremental and/or iterative modifications to the input pipeline. The further output revenue can be based on changes to advertisement placement, messaging, email messages, and so on. Further embodiments can include evaluating a pipeline generation activity for impact on the output revenue. A pipeline generation activity can include increasing activity with resellers, identifying and developing leads, etc.

The system 800 can include a computer program product embodied in a non-transitory computer readable medium for analysis, the computer program product comprising code which causes one or more processors to perform operations of: selecting, using a software dashboard graphical user interface, a predictive growth algorithm from a plurality of predictive growth algorithms; developing enterprise-specific revenue goals, employing code executed as a result of using the software dashboard graphical user interface, wherein the enterprise-specific revenue goals are based on the predictive growth algorithm which was selected; disaggregating the enterprise-specific revenue goals into subgoals for portions of the enterprise, using the software dashboard graphical user interface, wherein the portions of the enterprise correspond to input pipelines for the enterprise; evaluating data, employing code executed as a result of using the software dashboard graphical user interface, from the input pipelines corresponding to the subgoals; identifying one or more deficiencies in the data, employing code executed as a result of using the software dashboard graphical user interface, wherein the one or more deficiencies in the data are with respect to accomplishing one or more of the subgoals; and recommending, by the software dashboard graphical user interface, further action to correct the one or more deficiencies to achieve the one or more subgoals.

Each of the above methods may be executed on one or more processors on one or more computer systems. Each of the above methods may be implemented on a semiconductor chip and programmed using special purpose logic, programmable logic, and so on. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for analysis comprising:
selecting, using a software dashboard graphical user interface, a predictive growth algorithm from a plurality of predictive growth algorithms;
developing enterprise-specific revenue goals, employing code executed as a result of using the software dashboard graphical user interface, wherein the enterprise-specific revenue goals are based on the predictive growth algorithm which was selected;
disaggregating the enterprise-specific revenue goals into subgoals for portions of the enterprise, using the software dashboard graphical user interface, wherein the portions of the enterprise correspond to input pipelines for the enterprise;
evaluating data, employing code executed as a result of using the software dashboard graphical user interface, from the input pipelines corresponding to the subgoals;
identifying one or more deficiencies in the data, employing code executed as a result of using the software dashboard graphical user interface, wherein the one or more deficiencies in the data are with respect to accomplishing one or more of the subgoals; and
recommending, by the software dashboard graphical user interface, further action to correct the one or more deficiencies to achieve the one or more subgoals.

2. The method of claim 1 further comprising quantifying a relationship between the enterprise-specific revenue goals and the input pipelines for the enterprise and using that quantifying in developing the subgoals for portions of the enterprise.

3. The method of claim 2 wherein the quantifying the relationship between the enterprise-specific revenue goals and the input pipelines is used in lead process refinement.

4. The method of claim 1 wherein the disaggregating of the enterprise-specific revenue goals into subgoals for portions of the enterprise is accomplished using an adaptive growth pipeline model.

5. The method of claim 1 further comprising representing the data from the input pipelines as well as the subgoals in a graphical representation and displaying the graphical representation through the dashboard graphical user interface.

6. The method of claim 5 wherein the representing includes a Sankey diagram.

7. The method of claim 1 further comprising apportioning revenue targets, based on the enterprise-specific revenue goals, to components of the input pipelines for the enterprise based on the subgoals.

8. The method of claim 1 wherein the subgoals are defined to enable accomplishment of the enterprise-specific revenue goals.

9. The method of claim 1 wherein the one or more deficiencies include an underperformance or an overperformance on the one or more subgoals.

10. The method of claim 1 wherein the further action to correct the one or more deficiencies enables accomplishment of the enterprise-specific revenue goals.

11. The method of claim 10 further comprising recursively developing enterprise-specific revenue goals and disaggregating the enterprise-specific revenue goals into subgoals based on implementation of the further action.

12. The method of claim 1 wherein the enterprise-specific revenue goals are based on previous business history and/or a database of quantified best practices.

13. The method of claim 1 further comprising importing historical output revenue benchmark data, using a software dashboard graphical user interface, wherein the historical output revenue benchmark data is used for projecting future output revenue, based on the further action that was recommended.

14. The method of claim 1 wherein the predictive growth algorithm is based on correlated data.

15. The method of claim 14 wherein the correlated data includes market condition parameters, industry codes, and competitor performance data.

16. The method of claim 1 further comprising extrapolating from correlation to causality between a factor from output revenue and a factor from the input pipelines.

17. The method of claim 16 wherein the factor from the input pipelines includes lead stage definitions, lead flows, and lead velocities.

18. The method of claim 1 further comprising predicting a future output revenue based on an incremental and iterative modification to the input pipelines.

19. The method of claim 18 further comprising evaluating a pipeline generation activity for impact on the future output revenue.

20. The method of claim 1 wherein the input pipelines comprise a leading indicator.

21. The method of claim 1 further comprising calculating a funnel outcome based on the input pipelines.

22. The method of claim 21 wherein the funnel outcome is used in predicting an output revenue.

23. The method of claim 21 wherein the funnel outcome comprises a lagging indicator.

24. The method of claim 1 further comprising cohorting different lead progress velocities across stages of business development, between the input pipelines and output, for impacts on output revenue.

25. The method of claim 1 wherein the predictive growth algorithm is based on a normative reference model.

26. A computer program product embodied in a non-transitory computer readable medium for analysis, the computer program product comprising code which causes one or more processors to perform operations of:
selecting, using a software dashboard graphical user interface, a predictive growth algorithm from a plurality of predictive growth algorithms;
developing enterprise-specific revenue goals, employing code executed as a result of using the software dashboard graphical user interface, wherein the enterprise-specific revenue goals are based on the predictive growth algorithm which was selected;
disaggregating the enterprise-specific revenue goals into subgoals for portions of the enterprise, using the software dashboard graphical user interface, wherein the portions of the enterprise correspond to input pipelines for the enterprise;
evaluating data, employing code executed as a result of using the software dashboard graphical user interface, from the input pipelines corresponding to the subgoals;
identifying one or more deficiencies in the data, employing code executed as a result of using the software dashboard graphical user interface, wherein the one or more deficiencies in the data are with respect to accomplishing one or more of the subgoals; and
recommending, by the software dashboard graphical user interface, further action to correct the one or more deficiencies to achieve the one or more subgoals.

27. A computer system for analysis comprising:
a memory which stores instructions;
one or more processors coupled to the memory wherein the one or more processors, when executing the instructions which are stored, are configured to:
select, using a software dashboard graphical user interface, a predictive growth algorithm from a plurality of predictive growth algorithms;
develop enterprise-specific revenue goals, employing code executed as a result of using the software dashboard graphical user interface, wherein the enterprise-specific revenue goals are based on the predictive growth algorithm which was selected;
disaggregate the enterprise-specific revenue goals into subgoals for portions of the enterprise, using the software dashboard graphical user interface, wherein the portions of the enterprise correspond to input pipelines for the enterprise;
evaluate data, employing code executed as a result of using the software dashboard graphical user interface, from the input pipelines corresponding to the subgoals;
identify one or more deficiencies in the data, employing code executed as a result of using the software dashboard graphical user interface, wherein the one or more deficiencies in the data are with respect to accomplishing one or more of the subgoals; and
recommend, by the software dashboard graphical user interface, further action to correct the one or more deficiencies to achieve the one or more subgoals.
